(19) United States
(12) Patent Application Publication
(10) Pub. No.: US 2013/0273209 A1
(43) Pub. Date: Oct. 17, 2013

(54) Bi-Colored Random Collets and Methods for Making Same

(71) Applicants: Stefan K. Baier, Hartsdale, NY (US); Eugenio Bortone, McKinney, TX (US); Iris Huang, Plano, TX (US)

(72) Inventors: Stefan K. Baier, Hartsdale, NY (US); Eugenio Bortone, McKinney, TX (US); Iris Huang, Plano, TX (US)

(73) Assignee: Frito-Lay North America, Inc., Plano, TX (US)

(21) Appl. No.: 13/446,538

(22) Filed: Apr. 13, 2012

(51) Int. Cl. A21D 13/00; A23L 1/216; A23L 1/212; A23L 1/304; A23L 1/302; A23L 1/308; A23L 1/10; A23L 1/325; A23L 1/31; A23L 1/20; A23L 1/305; A23L 1/221; A23L 1/30; A23P 1/12; A23L 1/27

(52) U.S. Cl. 426/72; 426/249; 426/549; 426/550; 426/653; 426/615; 426/74; 426/618; 426/629; 426/643; 426/641; 426/634; 426/650; 426/61

(57) ABSTRACT

An expandable starch-based component is extruded through a random extruder together with a colored component having a color unlike that of said starch-based component. The starch-based component may include cereal grains such as rice or corn meal or components derived therefrom. The colored component may include colored starches such as blue corn meal; seeds; and/or micropellets made from fine particle ingredients. When combined, the components form a color-comprising mixture that can be extruded into colored or colorful collets. The color-comprising mixture comprises between about 2% to about 10% colored component. The produced bi-colored collets may then be cooked, optionally seasoned and packaged for consumption.

### BACKGROUND

1. Technical Field

The present invention generally relates to the production of direct expanded (i.e., puff extruded) farinaceous food products having unique colors and/or colored patterns. In particular, the invention is directed towards methods and formulations for imparting unique and distinctive bi-coloration contrasts or marbled effects onto an extruded food mass produced by random extrusion.

2. Description of Related Art

Corn collets, produced and marketed under the Cheetos® brand label, remain popular consumer items for which there exists a great demand. These corn collets are generally made by extruding moistened corn meal through an extruder, followed by a drying step such as baking or frying to remove additional moisture after extrusion. Since the introduction of extruders in the industry, many different varieties of these cornmeal snacks have been introduced. However, corn, or cornmeal, remains by far the most common ingredient used for these direct-expanded snack food products; not only due to the desirable expansion properties of corn, but also due to the equipment (or extruder) that dictates and often limits the range of usable raw materials.

FIGS. 1A and 1B depict one well-liked variety of corn collets, known as random collets, having unique, twisted (“random”) shapes and protrusion. These dense collets comprise a unique and highly desirable crunchy texture that can only be produced via random extrusion processes, which utilize a random extruder. It is a widely known and generally accepted fact in the industry that random extruders (also known as collet extruders) cannot handle flour-sized or powder-like granular materials. Instead, corn grits or corn meal comprising larger particle sizes are typically used in the random extruder to create the collets shown in FIGS. 1A and 1B. Although some amounts of rice meal may also be incorporated into the random extruder to produce the collet, there is little to no distinguishable color contrast between the corn meal and rice meal. Thus, to date the product remains substantially monochromic, with any variation in color attributed by the seasonings topically applied onto the corn collet. While topically applied seasonings applied to the surface of the collet may be used to change its coloring (as depicted by the seasoned collet in FIG. 1B), the “base” (i.e., pre-seasoned) collet (as depicted in FIG. 1A) currently substantially comprises only one color.

Research has shown that it is not only the taste of the corn collet that makes it so popular but also the fun that it provides to the eating experience. As such, collet products may be found in a variety of different shapes and sizes. However, it remains desirable to incorporate different colors into the popular collet to create other distinctive and visually appealing collet products with the same great taste and texture.

Consequently, there is a need for a method of providing for further visually appealing snack food products with unique and distinctive colors and patterns onto the collet products. Such a method should be able to produce collets having more than one color while using existing equipment and the extrusion technology typically used to create random corn collets. Preferably, such changes in color would have no negative impact upon the flavor of the snack food product. Moreover, such methods should provide for continuous production of the collets, while maintaining their desirable, crunchy texture and density.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1A is an illustration of a typical corn collet after random extrusion and prior to any seasoning steps as known in the industry.

FIG. 1B is an illustration of a typical seasoned corn collet ready for consumption.

FIG. 2 is a perspective view of a random extruder typically used in manufacturing collets.

FIG. 3 is a detailed view of the main components of the random extruder.

FIG. 4 depicts a flow chart of one embodiment of the method described herein.

FIG. 5 is an illustration of a collet produced by the method described herein.

FIG. 6A depicts a differential scanning calorimetry scan for colored micropellets used in accordance with one embodiment.

FIG. 6B depicts a differential scanning calorimetry scan for micropellets made by way of marumerization.

FIG. 7A depicts a rapid visco analyzer pasting curve for the colored micropellets used in accordance with one embodiment.

FIG. 7B depicts a replicate rapid visco analyzer pasting curve for the colored micropellets of FIG. 7A.

FIG. 8A depicts a rapid visco analyzer pasting curve for micropellets made by way of marumerization.

FIG. 8B depicts a replicate rapid visco analyzer pasting curve for the micropellets of FIG. 8A.

FIG. 9A depicts a phase transition analyzer scan for the colored micropellets used in accordance with one embodiment.

FIG. 9B depicts a replicate phase transition analyzer scan for the colored micropellets of FIG. 9A.

FIG. 10A depicts a phase transition analyzer scan for micropellets made by way of marumerization.

FIG. 10B depicts a replicate phase transition analyzer scan for the micropellets of FIG. 10A.

### DETAILED DESCRIPTION

The methods and formulations for the production of uniquely colored snack food products described herein provide for the addition of unique bi-colored or marbled color patterns within the extruded mass or base portion of a “random” collet. Applicants are able to combine the much-loved texture and taste of the random collet with more distinctively colored and unique patterns, to provide an enjoyable eating experience. By understanding and embracing the limited mixing properties of the random extruder, distinct visual characteristics are achieved without reliance on seasoning steps following expansion of the snack foods.

The method generally comprises introducing a substantially monochromic starch-based component into a random extruder, said starch-based component comprised of at least one expandable starch; introducing a non-liquid colored component into the extruder, wherein the component comprises a color unlike that of said monochromic starch-based component, thereby forming a color-comprising starch-based mixture; and extruding the mixture through the random extruder, thereby producing a plurality of colored random collets.

Generally, the extruded mixture comprising the starch-based component and colored component should comprise at least about 2% colored component. In one embodiment, the colored component comprises no more than about 5% of said extruded mixture. In one embodiment, the ratio of starch-based mixture to non-liquid colored component introduced into the extruder is about 9:1. In another embodiment, ratio or starch-based component to non-liquid colored components is no more than 19:1. In one embodiment, the ratio of the starch-based component to the colored component is between about 95:5 to about 98:2. Once extruded, the collets may undergo further processing such as cooking or dehydrating steps, seasoning and packaging for subsequent consumption by consumers.

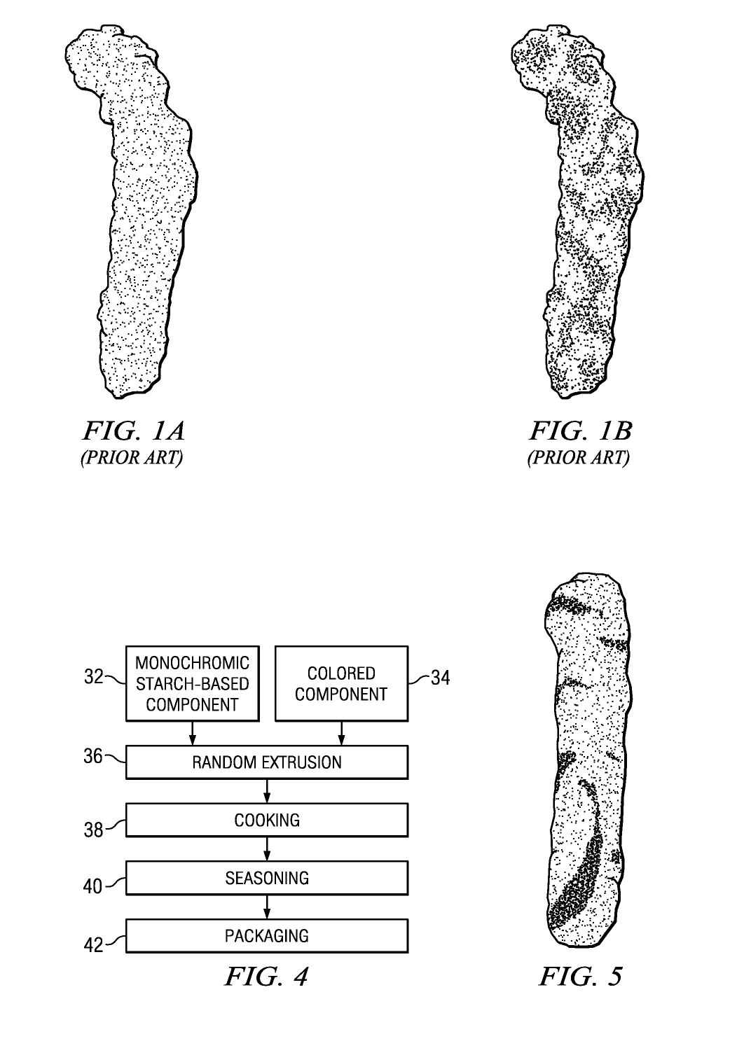

While the number of raw materials used to create extruded snack products continues to grow, the random corn collet, as described above in relation to FIGS. 1A and 1B, remains substantially monochromic. As used herein, a “random collet” is meant to refer to a collet (food) product produced using a random extruder. As used herein, the phrase “substantially monochromic” is meant to refer to the characteristic of having or appearing to have only one color, regardless of whether or not more than one hue or shade of color is present in the base of a collet when viewed up close. Thus, a “substantially monochromic collet” overall appears to comprise a single color, with no significant differences or variations between colors. A “bi-colored collet” as used herein is meant to refer to a collet perceptibly having more than one color. Thus, bi-colored collets may comprise bi-colored, tri-colored, or multi-colored patterns.

### Random Extrusion

To better understand the limitations of the random extruder and the advantages provided herein, a discussion of the inner workings of a random extruder follows. It should be noted that there are several manufacturers of random extruders; however, the fundamental design is very similar. Random extruders are high-shear, high-pressure machines, which generate heat in the form of friction in a relatively short length of time. No barrel heating is applied in random extruders, as the energy used to cook the extrudate is generated from viscous dissipation of mechanical energy.

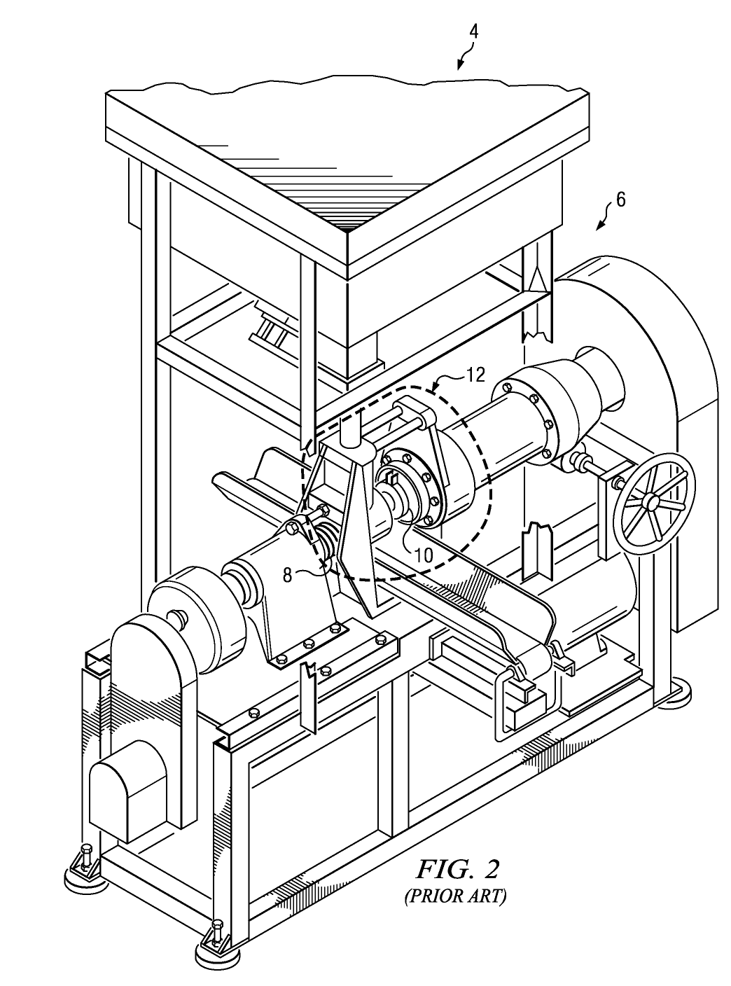

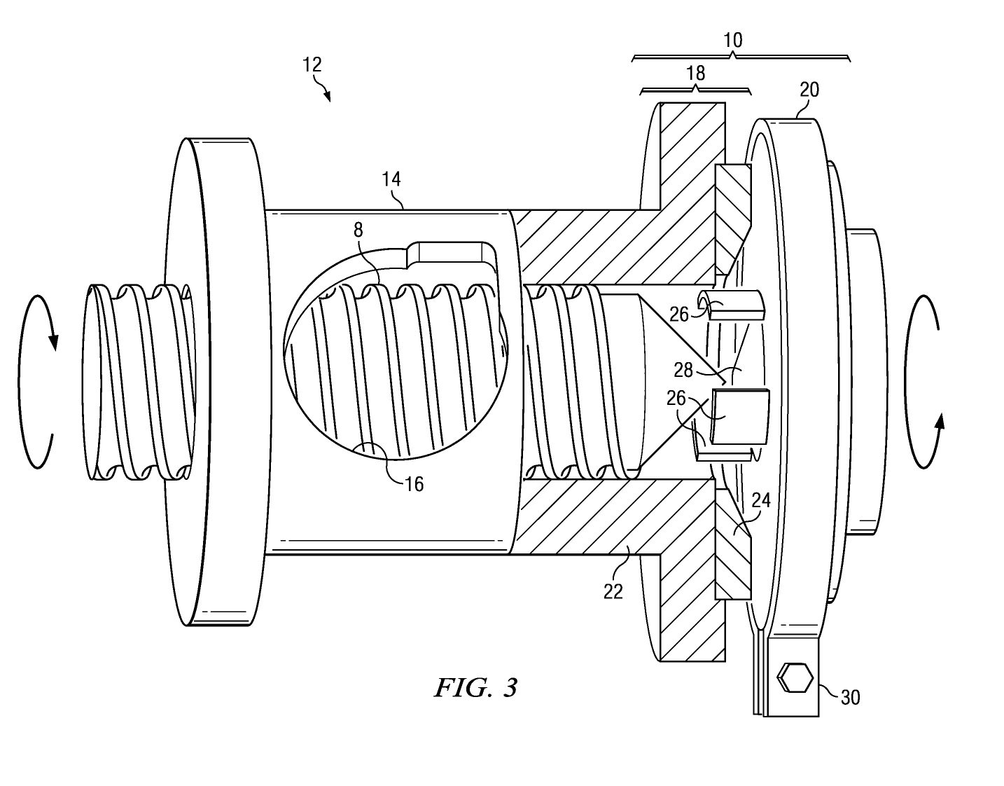

FIG. 2 illustrates a perspective view of a typical random extruder used for production of the random corn collets 2 depicted in FIGS. 1A and 1B. Pre-moistened cornmeal is gravity-fed through a hopper 4 and into the random extruder 6. In this manner, the extruder 6 is choke-fed, taking in all it can take. The random extruder 6 is comprised of two main working components: a single screw or auger 8 and a special die assembly (also known as a dynamic die) 10 that gives the collets their twisted (“random”) shapes. FIG. 3 illustrates a close up, more detailed image of the main working components 12 of the random extruder 6. The auger 8 is housed in a cylindrical casing, or barrel 14, and comprises an open feed section 16 through which the cornmeal passes. The auger 8 then transports and compresses the cornmeal, feeding it to the die assembly 10. Once the auger 8 conveys the material into the dynamic die assembly, the working components grind and plasticize the formulation to a fluidized state in a glass transition process.

As best shown in FIG. 3, the die assembly 10 is comprised of a stator 18 and a rotor 20. Gelatinization of moisturized starchy ingredients takes place inside the concentric cavity between these two brass plates 18, 20. The stator 18 is a round stationary brass plate that acts as a die through which the gelatinized melt flows. The stator 18 comprises a stator base section 22 and a stator head 24 with grooves (not depicted) that aid in the compression of cornmeal as the stator 18 works together with the rotor 20, which is a rotating plate comprising fingers (or blades) 26 and a nose cone 28. The nose cone 28 channels the cornmeal towards the fingers 26 and discharges the gelatinized cornmeal. The action of the fingers 26 creates the necessary condition of pressure and heat to achieve gelatinization of the raw materials at approximately 260° F. (127° C.). Specifically, the fingers 26 force cornmeal back into the grooves of the stator head 24, causing friction and compression of the cornmeal in the head gap y. The brass rotor facing on the rotor 20 also helps to create heat and compression. Random extrusion may thus be characterized by a thermo mechanical transformation between the metal to metal interactions of the main working components in a random extruder.

Several things happen within the die assembly 10 during the random extrusion process. First, the corn meal is subjected to high shear rates and pressure that generate most of the heat to cook the corn. Thus, unlike other extruders, most of the cooking takes place in the special die assembly 10 of the random extruder. Second, a rapid pressure loss causes the superheated water in the corn mass to turn to steam, puffing the cooked corn. Third, the flow of corn between one rotating plate 20 and one stationary plate 18 twists the expanding corn leaving it twisted and collapsed in places, resulting in the product characteristic shape shown in FIGS. 1A and 1B. Cutter blades within a cutter assembly 30 then cut off the collets 2 that result from the expansion process of the stator-rotor interactions. The process is entirely unique, providing unsystematic, irregularly shaped collets and a texture distinct in its crunchiness.

To date, due to the limited conveyance and mixing properties of the random extruder, formulations for random extrusion substantially comprise only corn meal, or corn grits. Anything other than the typical corn meal formulation will block the extruder and halt production. Unlike most other extrusion processes, the random extruder 6 and its single auger 8, best seen in FIG. 3, only provide for the pumping of the cornmeal through the die, with most of the cooking actually taking places in the die assembly 10, where the cornmeal is cooked and heated to around 180° C. Thus, the conveyance and delivery of the material into the rotating die is important in ensuring the proper cooking and production processes. Adequate conveyance in the random extruder 6 is dependent, among other things, upon the particle size characteristic of the material used, as the random extruder 6 cannot handle fine or dusty material such as any flour. Fines cause fouling or surging problems, resulting in an undesirable accumulation of deposits on the heat transfer surfaces that can lock up the random extruder's die assembly. For example, even in small amounts, corn meal flour tends to segregate in the hopper 4, producing very thin collets seen with pockets of segregated fines. Large pockets of moisture eventually block the extruder, delaying and/or halting mass production.

While other extruders may provide more flexibility in terms of the components that may be introduced therein, only random extruders can create the random collet 2, which upon exit from the random extruder, comprises a bulk density of between about 4.0 to about 5.50 lbs/cu ft. Twin screw extruders (TSE), for example, are less dependent upon frictional properties as they provide for a positive displacement transport with the intermeshing of rotating twin screws. Thus, TSEs are more flexible due to their conveying mode and mixing characteristics. However, these extruders typically produce a different variety of collet; namely, corn puffs that comprise a relatively smoother surface and a more rod-like cylindrical shape with a lighter density upon exiting from an extruder. By way of example, upon exiting from a TSE, corn puffs typically comprise a bulk density ranging from between about 1.8 to about 2.8 lbs/cu ft, depending on size. Thus, while the TSE has better conveying and pumping capabilities, and therefore greater flexibility for formula variation, TSE is not capable of producing the denser random collet. Moreover, the TSE comprises mixing properties that does not allow for any visible contrast in color in collets produced as described herein. By embracing the poor mixing abilities of the random extruder, the method described herein provides for a variety of ingredients to be introduced into the extruder; in particular, ingredients that allow for unique colorations onto the base of the collets.

### Bi-Colored Collets

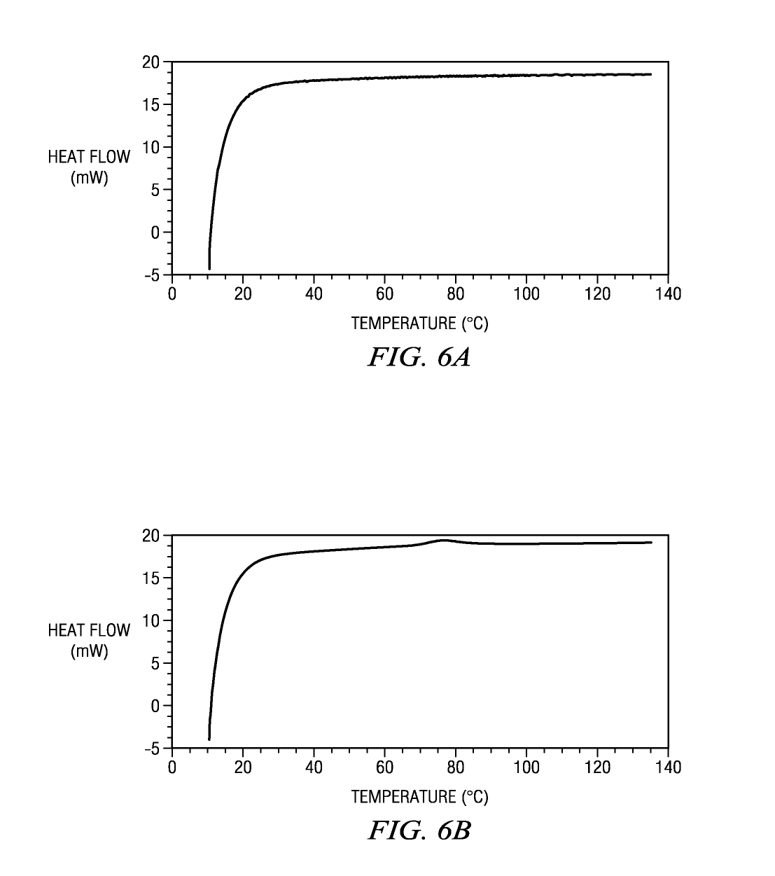

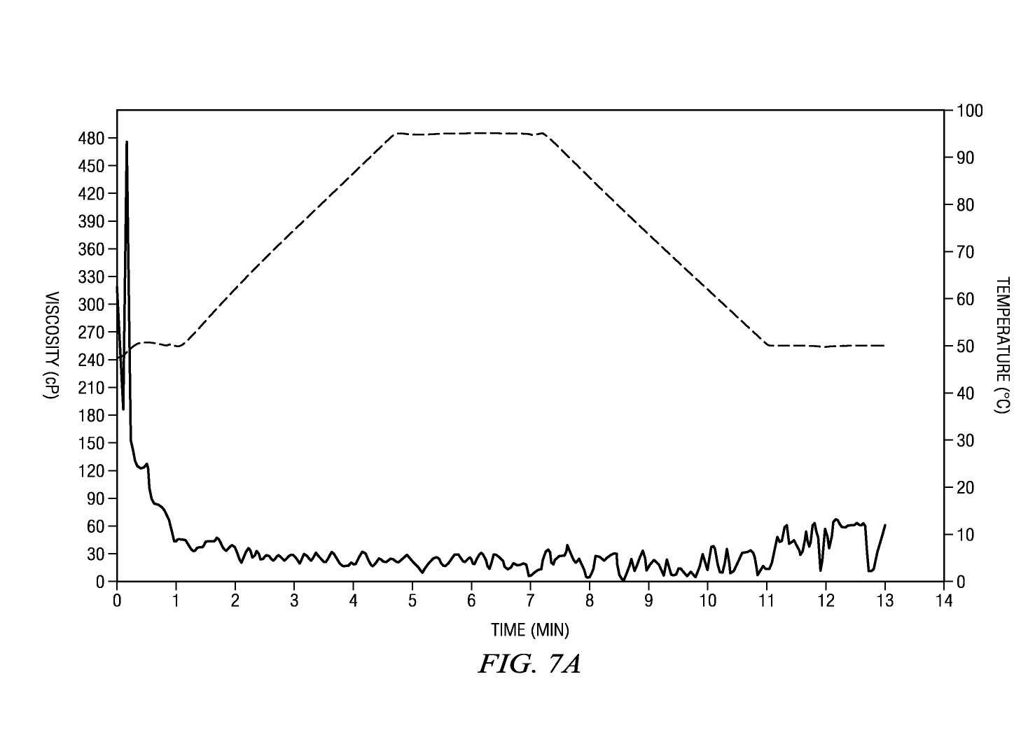

One embodiment will now be described with reference to FIG. 4, which depicts a flowchart of the basic method. A substantially monochromic starch-based component 32 is introduced or fed into a random extruder. The monochromic starch-based component 32 should comprise at least one expandable starch or starch derivative, and in general, should comprise a plurality of discrete particles. In one embodiment, the monochromic starch-based component consists of a plurality of non-agglomerated, discrete particles. As used herein, the term “expandable starch” is meant to refer a starch or starch derivative comprising a property that allows is to expand to many times its original volume; in this case, when subjected to random extrusion. Thus, an expandable starch may comprise any cereal grain that offers expansion in a random extruder. With reference back to FIG. 2, the starch-based component 32 may be fed into the extruder via the feed hopper assembly 4 disposed immediately above the extruder 6.

a. Monochromic Starch-Based Components

As described above, the term “monochromic” is meant to refer to a substance comprising a single color, or different shades of a single color. Thus, a “substantially monochromic” starched based component as used herein is meant to refer to a starch comprising component having a single color or substantially having a single color, wherein more than one gradation or shade of a color (i.e., hues) may be somewhat visible to the naked eye but the untrained eye will typically perceive a single color. The “monochromic starch-based component” may comprise one starch, or more than one starch (i.e., a mixture of starches), so long as it substantially has or appears to have only one color, whether or not said color appearance is comprised of different shades of a single color. In one embodiment, the substantially monochromic starch-based component 32 may comprise any starch traditionally used to produce random collets, or any combination of starches thereof. It should further be noted that the starch based component 32 may comprise non-starch particles provided that the non-starch particles not affect expansion of the starch-based component 32, or its monochromic state.

From a technical perspective, the CIE system of colorimetry can be used to describe or quantify the difference between any two colors in a suitable monochromic starch-based component 32. A color difference formula called CIE-Lab, published by the International Commission on Illumination (CIE) in 1976, is one mathematical way to quantify the color differences between two objects.

ΔE=[(ΔL*)²+(Δa*)²+Δb*)²]^{1/2}

In this formula, the difference between two colors is expressed in delta-E units, where a delta E value of zero represents a perfect match and a large delta-E value represents a poor color match. In other words, generally, the lower the delta E value, the smaller the color difference. In addition, the L value represents white to black or lightness to darkness, wherein L=100 is equivalent to white; the a value represents red to green such that positive equates to red and negative equates to green; and the b value represents yellow to blue such that positive equates yellow and negative equates to blue. In one embodiment, any color differences within the monochromic starch based component 32 comprise a delta E value of from 0 to about 1.0, which is meant to represent a normally invisible or undetectable difference. In another embodiment, a color difference comprises a delta E value of between about 1 to about 2, representing a very small difference, only obvious to a trained eye. In another embodiment, any color difference of the starch based component 32 comprises a delta E value of about 2 to about 3.5, meant to represent minute color differences or variations, more obvious to an untrained eye. Those skilled in the art will appreciate that defining color differences in terms of delta E values is a simplified approach, and that a number of ways exist that can measure color differences. Nevertheless, delta E values may serve as a guide for determining suitable particles for inclusion within the monochromic starch based component 32.

In one embodiment, the monochromic starch-based component 32 comprises discrete particles that are not subjected to artificial coloring processes; however so long as the starch-based component 32 comprises a color unlike that of the introduced coloring components 34 to produce visible color differences on the base of an unseasoned collet, any starch-based component 32 may be used. Suitable monochromic starch-based component(s) may comprise, for example, white to yellow corn meal, rice meal, and other products derived from rice, corn and/or cereal grain products with an ability to expand during random extrusion.

In one embodiment, the monochromic starch-based component 32 comprises corn meal. Such corn meal may be any variety of white or yellow corn meal. In another embodiment, said starch-based component 32 comprises rice meal. In another embodiment, the starch-based component 32 may be selected from the group consisting of rice, corn, potato, or any combination or derivation thereof. Corn or rice products suitable for use with the random extrusion processes described herein are commercially available from any number of manufacturers and easily obtainable by one skilled in the art. For example, any corn meal as typically traditionally used in the art to create random collets (i.e., collets produced with a random extruder) may be selected as a suitable starch-based component 32.

In another embodiment, the monochromic starch-based component 32 may comprise a plurality of monochromic discrete agglomerated substances or micropellets, each of which is comprised of agglomerated particles containing starch. As used herein, the term “agglomerate” relates to the product of some size enlargement process such as one resulting in a substantially solid micropellet as described herein. For example, powders, flours or similarly-sized components comprising starch may be agglomerated into micropellets. Suitable starches for agglomeration within the micropellets include without limitation corn, rice, and potato or products derived therefrom. Thus in one embodiment, the monochromic micropellets comprise one or more of corn, rice, potato, a starch component derived from corn, rice, or potato, or any combination thereof. It should be noted that embodiments wherein the starch-based component 32 may be selected from the group consisting of rice, corn, potato, or any combination or derivation thereof include the plurality of monochromic micropellets. Starch components within the plurality of monochromic micropellets may be modified or native. In one embodiment, the starch-comprising component is selected from the group consisting of the following: waxy corn starch, native corn starch, rice, tapioca, whole grain cereals, potato starch, or any combination or a starchy component thereof. In one embodiment, the starch-comprising component comprises Maltodextrin. In another embodiment, the starch-comprising component may be derived from the starch components of whole grain corn. Such components are widely available from any number of manufacturers. Suitable methods of agglomeration are further discussed below with regard to an embodiment of the colored component, or colored micropellets.

b. Colored Components

With further regard to the method depicted in FIG. 4, in the same way as the starch-based component 32 is introduced, a colored component 34 is fed into the extruder through a hopper 4 (shown in FIG. 2), wherein said colored component comprises a color unlike that of said monochromic starch-based component 32.

Generally, the color difference between the colored component 34 and the starch-based component 32 is sufficiently different such that a perceptible difference is visible to the naked eye, or the colors are simply not visually close. Using the CIE system of colorimetry, suitable differences between the color properties of the components 32, 34 comprise a delta E value greater than 3.5. In one embodiment, the colored component 34 is introduced into the extruder feeder port by partition feeding the component 34 and the starch-based component 32 through the hopper 4 of the random extruder 6. Thus, in one embodiment, the steps of introducing the monochromic starch-based component 32 and the colored component 34 are performed simultaneously. In one embodiment, the starch-based component 32 and the colored component 34 are pre-blended or combined together prior to introduction into a random extruder for extrusion. In another embodiment, the steps of introducing the monochromic starch-based component 32 and the colored component 34 are performed sequentially.

The colored component 34 is preferably in non-liquid form when introduced into the random extruder. In other words, the colored component 34 is substantially solid when introduced into the random extruder or when combined with the starch-based component 32. In one embodiment, the colored component comprises discrete agglomerated particles. It should be understood that the colored component 34 may comprise either natural or artificial coloring, so long as it comprises a color unlike that of the starch-based component 34.

i. Natural Substances

The colored component 34 may comprise natural or manufactured substances. In one embodiment, the colored component 34 comprises natural seeds derived or obtained from a plant, or a seed material providing a pigment naturally unlike that of said starch-based material. In some embodiments, seeds may be ground to a discrete particle size. In one embodiment, the colored component comprises seeds of between about 250 to about 600 microns. In one embodiment, the seeds comprise a size substantially similar to that of the starch-based component 32, wherein between about 75% to about 100% of the colored seed components 34 comprise the same size, or substantially the same size, as at least 75% of the starch-based component 32. By way of example, Table 1 provides a typical corn meal particle size distribution.

TABLE 1
Corn meal Specifications

| US sieve size | Typical analysis (%) |
|---|---|
| on 16 | 0 |
| on 20 | <1 |
| on 25 | 9 |
| on 30 | 43 |
| on 40 | 45 |
| on 50 | 2 |
| through 50 | <1 |

Suitable exemplary seeds include without limitation any seeds used to produce food coloring such as annatto. Annatto is a derivative of the achiote tree and is also used to produce flavoring. In some embodiments, the colored component may further provide for varied flavor into the collet. Seed materials further provide varied texture in some embodiments.

In another embodiment, the colored component 34 may comprise a blue corn meal, which naturally comprises a blue or purple-like pigment. In another embodiment, the colored components may comprise an expandable starch that has been subjected to an artificial coloring process to produce a colored component 34 with a color unlike that of said starch-based mixture 32. Preferably, such a coloring process would involve fat-soluble color in order to ensure a slow diffusion or dissipation rate of the color, within the short mixing regions of the random extruder. Any coloring process used should be performed far enough in advance so as to allow the color to set and be internalized into the starch or meal. If necessary, a drying step may be performed. The coloring should provide the colored component 34 with a moisture content similar to that of the starch-based component 32. In embodiments comprising artificial coloring methods to the colored component 34, both the starch-based component 32 and the colored component 34 may undergo pre-hydration steps to avoid bleeding of the color prior to random extrusion. In one embodiment, both the mixture and component are tempered to equalize the moisture contents of each to between about 11% to about 15.5%. By way of contrast, moisture contents currently used for corn meal typically range from between about 16.5% to about 17%.

ii. Agglomerated Substances

In another embodiment, the colored component 34 comprises a plurality of colored micropellets, each of which is comprised of agglomerated fine particles. The phrase “fine particle” or “fine” is used to refer to powders, flours, and any other similarly sized fine materials comprising small particles having a particle size of between about 150 to about 250 microns in diameter (or less than 60 mesh) for incorporation into foods. Thus, the fine particles selected for agglomeration into the micropellets comprise a particle size of between about 250 microns or less in diameter (or less than 60 mesh). For example, powders, flours or similarly-sized components may be agglomerated into micropellets that survive the random extrusion process.

Agglomeration transforms fine particles into larger particles by the introduction of external forces, and is known to add value to many processes in a number of industries involving the use of finely divided solid materials. For example, in the food industry, agglomerated flours have been particularly useful in the production of foods known for the convenience factor of instant preparation, wherein agglomerates are prepared so that they will instantly disburse or dissolve in liquids. However, to date, these technologies have yet to be successfully introduced into snack foods as described herein.

Generally, where the colored component 34 is a plurality of food-grade micropellets, each micropellet is comprised of agglomerated fine particles and each comprises the color unlike that of said monochromic starch-based component 32. Suitable fine ingredients may include, for example, flours or powders comprising starch, proteins, fruits, berries, vegetables, minerals, vitamins, herbs, fibers, grains, beans, fish, seafood, meats, peas, vegetable proteins, flavors, probiotics, or any supplements thereof, whether natural or artificial, as well as any combination thereof, so long as they are agglomerated into a micropellet comprising a color visibly different from the monochromic starch-based component 32.

In one embodiment, a micropellet comprises a plurality of fine particles agglomerated together with a starch-comprising component. In one embodiment, a micropellet consists of a plurality of fine particles agglomerated together with a starch-comprising component. In another embodiment, a micropellet may consist entirely of fine particle components, wherein said fine particle components comprise the coloring unlike that of said substantially monochromic starch based component 32. So long as the micropellets comprise a coloring unlike that of said substantially monochromic starch-based component 32, a bi-colored collet can be produced. One skilled in the art, armed with this disclosure, should recognize any number of combinations of components that may be agglomerated within the micropellets in order to achieve the desired coloration effects.

It should be noted that in embodiments using monochromic micropellets as described above with regard to the monochromic starch-based component, the method comprises the steps of introducing a substantially monochromic starch-based component into a random extruder, said starch-based component comprised of at least one expandable starch and wherein said substantially monochromic starch-based component comprises a first plurality of substantially monochromic discrete micropellets; introducing a non-liquid colored component into the extruder, said colored component comprising a second plurality of discrete micropellets, wherein the colored component comprises a color unlike that of said monochromic starch-based component, thereby forming a color-comprising starch-based mixture; and extruding the mixture through the random extruder, thereby producing a plurality of colored random collets.

In general, the micropellets described herein are substantially solid small pellet agglomerates comprising a spherical or cylindrical shape and a diameter no larger than about 1.8 mm (1800 microns). The micropellets should further comprise a size of at least about 0.5 mm (or 500 microns). In one preferred embodiment, the micropellets mimic the granular characteristics and/or particle size of corn meal or corn grits. Thus, in one embodiment, micropellets comprise a size of about 500 to about 700 microns (or about 0.5 mm to about 0.7 mm). In some embodiments, the micropellets comprise a size of about 500 microns (0.5 mm). In another embodiment, the micropellet agglomerates comprise a short length with a diameter of about 0.8 mm. In another embodiment, the micropellet agglomerates comprise a longer length of about 4 mm, with a diameter of about 0.8 mm. In one embodiment, the micropellets comprise a diameter of between about 0.5 mm to about 1.0 mm. In another embodiment, the micropellets comprise a diameter of between about 0.5 to about 0.8 mm. In one embodiment, the micropellets comprise a particle size distribution wherein at least 75% of the micropellets are larger than 50 mesh. More preferably, at least 90% of the agglomerates are larger than 50 mesh. Most preferably, at least 99.9% of the agglomerates are larger than 50 mesh. Micropellets comprising smaller diameters are also possible in some embodiments; however, it may be preferable to pre-expand or pre-puff these to a larger particle size before random extrusion. For example, air puffing, microwaving, roasting, or baking to heat the micropellets to a temperature of about 350° F. provides for an increase in size or expansion of micropellets comprising a particle size of less than about 0.5 mm in diameter. Similarly, micropellets comprising larger size may be ground down to appropriate size for random extrusion.

While in some embodiments it may be desirable to create colored components capable of expansion, in alternate embodiments, colored components having no expansion properties at all may be included into the bi-colored food products described herein. For example, colored components in the form of micropellets may or may not comprise an expandable property. Expandable colored micropellet embodiments should generally comprise fine particles agglomerated together with a starch-comprising component, which may be present in varying concentrations of from between about 20% to about 40%, with the remainder comprising the fine particles or powders, and/or minor amounts of other flour components such as salt, fiber, or a nucleating agent such as Methyl Carboxyl Cellulous (MCC). In one embodiment, the micropellet may comprise up to about 10% MCC. In some preferred embodiments, the starch-comprising component within the micropellet is one that gelatinizes upon cooking. When subjected to random extrusion, a micropellet may completely melt in the starch matrix of a formulation introduced into the extruder; or, alternatively, the micropellet will survive the shear in the random extrusion process, but expand upon exit from the extruder die. Thus, in some embodiments, micropellets are capable of plasticizing into a viscoelastic dough and comprise an expanding property, which causes the melting or expanding of the micropellets when subjected to random extrusion.

In alternate embodiments, the colored components are not capable of expansion (i.e., comprise no expansion properties) but rather are used to add variation in color when combined with a starch-comprising component to form the color comprising mixture. In some embodiments, the color components 34 may also further add variation in texture and/or flavor to the collet. For example, colored micropellets may be completely comprised or cellulose, which does not expand but can be included in snack products. However, when agglomerating fine particles with no expansion capabilities, it remains desirable to mix or disperse non-expandable micropellets with a starch comprising component, or into a starch matrix. Put differently, micropellets not capable of expansion should be included within expandable formulation before extrusion. Generally, such a micropellet-containing formulation should comprise at least about 20% of an expandable starch such as corn meal. Thus, some expandable property is generally desirable, whether such property is provided by an expandable starch included within the micropellet or by a starch mixed together with the micropellets prior to exiting a random extrusion die.

The starch-comprising component of an expandable micropellet may be derived from a plant. Suitable starch-comprising components for agglomeration within the micropellet include without limitation corn, rice, potato and any product derived therefrom. Thus in one embodiment, the micropellets comprise a starch-comprising component selected from the group consisting of corn, potato, rice, or products derived therefrom. Such starch components may be modified or native. In one embodiment, the starch-comprising component comprises waxy corn starch. In one embodiment, the starch-comprising component comprises potato starch. In one embodiment, the starch-comprising component comprises corn meal. In one embodiment, the starch-comprising component of a micropellet is selected from the group consisting of the following: waxy corn starch, native corn starch, rice, tapioca, whole grain, potato starch, or any combination thereof. Such components are widely available from any number of manufacturers.

The micropellets described herein can be formed by a variety of agglomeration technologies so long as the process produces micropellets of the size and shape described, in which there is a high degree of cook (substantially 100%) so as to form a crystalline structure. Micropellets that do not form this crystalline structure when subjected to the random extrusion process would basically become powder in the screw feeder and choke the machine, halting production as with non-agglomerated fine particles.

One preferred method that may be used to manufacture the micropellets is extrusion, which basically requires extruding material through a cooking extruder to pre-cook the materials in forming a dough followed by a forming extruder with a die. The resulting strands can then be cut to form micropellets of uniform shape and size. Pre-cooking is performed using either a single or twin screw (cooking) extruding, followed by a forming extruder, which forms the dough into spaghetti-type strands using a die head attached to a high rpm cutter. During some trial runs, micropellets were pre-cooked in a single screw extruder run with a low shear configuration designed for pellet production. A suitable forming extruder, for example, is a G55 cooking extruder manufactured by Pavan.

The components of the micropellet are placed either manually or with the help of unloading equipment into supply hoppers. A mixture of dry fine ingredients and liquids is premixed at high speed and is then cooked and extruded using an extrusion screw with modular sections and a jacketed cylinder with multiple cooking stages having independent temperatures. Comparable cooker extruders may also be employed. By way of example, a suitable forming extruder for the production of micropellets from pregelatinized raw materials is a F55 former-extruder known under the brand name Pavan. This extruder uses interchangeable dies and a cutting group. Pre-cooked mixtures of a homogenously hydrated and stabilized dough is formed using a compression screw, a cylinder with heating/cooling system, a headpiece and a die to form the product. Typically, there is a shaping die at the outlet of its downstream end, with a knife or knife cutting system located after the die. Formed spaghetti-type strands were cut into micropellets, collected via hopper and dried overnight in forced air convection and cooled in dryer temperatures of about 44° C. in a relative humidity of 66% for about 480 minutes drying time. Preferably, when introducing heat-labile components, low shear mixing occurs such that the mixing agitators and mixing speeds do not degrade or denature any proteins, flavors or other nutrients within the micropellet. These mixing components help to produce a uniform blend of ingredients with a dough-like consistency through a distributive zone of the extruder. Liquid inlets of the extruder ensure proper conditioning or moisture addition into the formulation. Shaping takes place in the extruder as the material is extruded through holes in the shaping die. In one embodiment, the die head comprises orifices of about 0.8 mm in diameter.

Wet extrusion and spheronization methods are also useful for formation of micropellets comprising heat-labile components because of the low shear involved. Thus in one embodiment, the micropellets are manufactured using the process of wet extrusion, followed by spheronization. As used herein, “spheronization” is used synonymously with the term “spheronizing,” and is meant to refer to the rounding of moist, soft cylindrical pellets in a spheronizer. While these processes are known in the field of pharmaceuticals, the formulations and the resulting micropellets described herein are not. Briefly, the pre-mixed dry ingredients comprising a non-starch powder and plant-derived starch first undergo a mixing step wherein they are moistened with water or water-based solutions (such as a food grade solvent) and mixed in a high shear granulator or double planetary mixer to form a homogenous wet mass suitable for wet extrusion. Next, the wet mass is metered by a special feeder into a low shear extruder, such as a low shear dome or radial extruder, where it is continuously formed under into cylindrical extrudrates of uniform shape and size. The low shear ensures that the extruder temperature never reaches more than 80° F., protecting the heat-labile ingredients of the micropellets. Third, the wet extrudates, which comprise rod-like shapes, are placed in a spheronizer where a gridded, fast spinning disc breaks them into smaller particles and rounds them over a period of about two minutes to form spheres. Fourth and finally, the wet spheres (also referred to as “beadlets”) are dried. This process can be performed as either a batch or continuous operation with the above steps.

It should be understood that these food-grade micropellets may be manufactured as described above or may be obtained or purchased from any vendor capable of manufacturing same. Applicants have found that by introducing these micropellets, the problem of poor conveyance of the random extruder is overcome and the micropellets are able to handle components not traditionally accepted by the random extruder. In creating the colored collets described herein, any number of colored flours or granulated products can be agglomerated to produce colored micropellets for introduction into a random extruder.

In one embodiment, the colored component 34 may comprise blue corn meal agglomerated into a micropellet as described above. In another embodiment, the colored component 34 may comprise an agglomerated flavored powder. For example, in one embodiment, the colored component 23 comprises chipotle flour agglomerated within a micropellet. A micropellet comprised of chipotle adds not only orange streaks to a collet base, but also introduces the chipotle flavor into the collets. Thus, in one embodiment, the colored component 34 comprises flavorings or seasonings to provide for bi-coloration or marbled effects while delivering flavors to the expanded products. In another embodiment, the colored component 34 comprises agglomerated sea vegetable powders. Some test runs, for example, included porphyra (nori), an edible sea vegetable with a dark green color characteristic into a random collet via a micropellet. In one embodiment, a sea vegetable micropellet may comprise about 10% sea vegetable Porphyra and between about 89% to 90% starch, with salt making up the balance (at about 1%). In another embodiment, the colored component 34 comprises a colored fruit powder or juice to produce micropellets with a color unlike that of the starch-based component 32 together with a starch-comprising component. For example, in some test runs, cranberry juice liquid, which comprises a purple color, was used together with corn meal to create micropellets for the creation of colored collets. In one embodiment, a cranberry micropellet comprises about 10% liquid cranberry juice, which was mixed and kneaded with about 90% corn meal within a TSE. After extruding into micropellet form, colored components 34 may be introduced together with the starch-based component 32. Thus, the micropellet may comprise about 10% of a liquid derived from one or more of proteins, fruits, berries, vegetables, minerals, vitamins, herbs, fibers, grains, beans, fish, seafood, meats, peas, botanical proteins, flavors, and probiotics.

c. Extruding the Mixture

With reference back to the method of FIG. 4, having selected a substantially monochromic starch-based component 32 and a colored component 34, the colored mixture for extrusion 36 will now be further described.

In one embodiment, the colored mixture for extrusion comprises at least about 2% colored component 34. In another embodiment, the mixture comprises no more than 10% colored component 34. In one embodiment, the mixture comprises no more than 5% colored component. In another embodiment, the mixture comprises between about 2% to about 5% colored component. In one embodiment, the mixture for random extrusion comprises a monochromic starch based component 32 and a colored component 34 at a ratio of about 98:2. In another embodiment, the starch-based component 32 to colored component 34 ratio is about 95:5. In one embodiment, the starch-based component 32 to colored component 34 ratio may range between about 98:2 to about 90:10.

As stated above, the components 32, 34 are introduced into a random extruder either simultaneously through a hopper 4 (FIG. 2) or may be pre-blended to form the colored mixture prior to introduction. The colored component 34 may also be introduced into the extruder just immediately after introducing the starch-based component 32 in another embodiment. One skilled in the art will recognize that when running the random extruder continuously, as in a commercial manufacture setting, colored collets will be formed when introducing the colored component 34 within sufficient time before the extrusion is complete.

The components 32, 34 may be introduced into a random extrusion processing line as known in the art. Briefly, the components 32, 34 are first hydrated. In one embodiment, the components 32, 34 may be hydrated separately before their introduction into the random extruder 36. In another embodiment, the components may be pre-blended together and equilibrated to a moisture content of about between about 11% and 15.5%. Hydrated components are then transferred to a bucket elevator, which transfers the components to an extruder hopper 4 of a random extruder. Extrusion 36 is then performed to form the bi-colored collets. As discussed above, such extrusion forms hard dense extruded product utilizing rotating brass plates.

Optionally, upon exiting the random extruder, the bi-colored collets may be conveyed to a fines tumbler to remove any small fines from the product before subjecting the collets to a final cooking step 38, which will further dehydrate the collets to form shelf-stable snack food products. For example, in the production of fried collets, the product may be fed to a fryer, such as a rotary fryer, which decreases moisture and adds oil to the extruded product. Following frying 38, the collets may be transferred to a coating tumbler, wherein oil, flavor and/or salt are mixed. The collets can then be turned in a flavor drum, which applies flavor (i.e., seasonings) to the surface of the collet 40. In one embodiment, the bi-colored collets are seasoned 40 using a light-colored seasoning such that the coloration of the base collet remains visible. For example, a white cheese seasoning 40 is preferred in some embodiments. However, any seasoning that complements the aesthetics and/or flavor of the collets may be used. After optional seasoning steps, the collets may be packaged 42 for subsequent consumption.

The micropellets described herein may comprise a low water absorption index and can thus last for a long time when submerged in water, absorbing very little moisture. In contrast, animal feed pellets, which typically are produced as complete meals, comprise a much higher dextrinization and very high water absorption, which causes the pellets to swell when exposed to water and break apart. Further analysis of the micropellets will now be described.

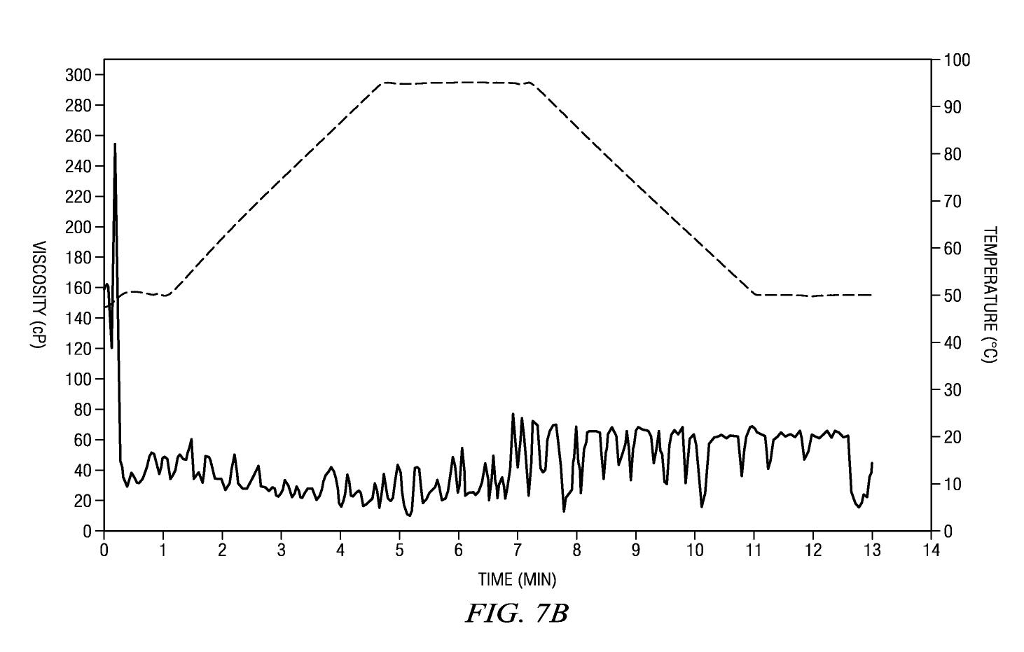

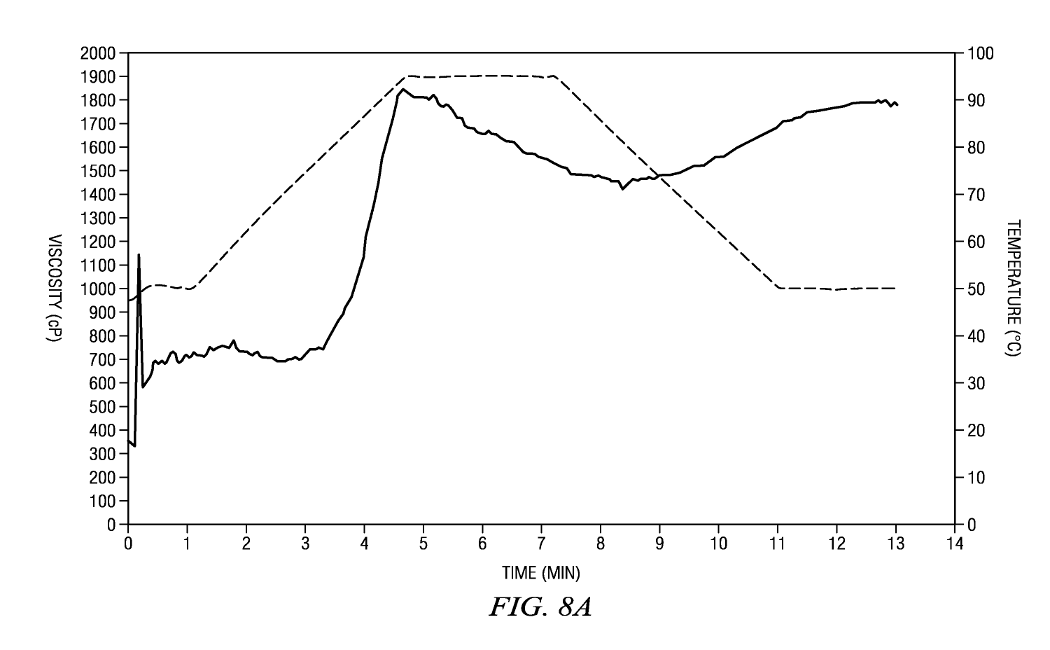

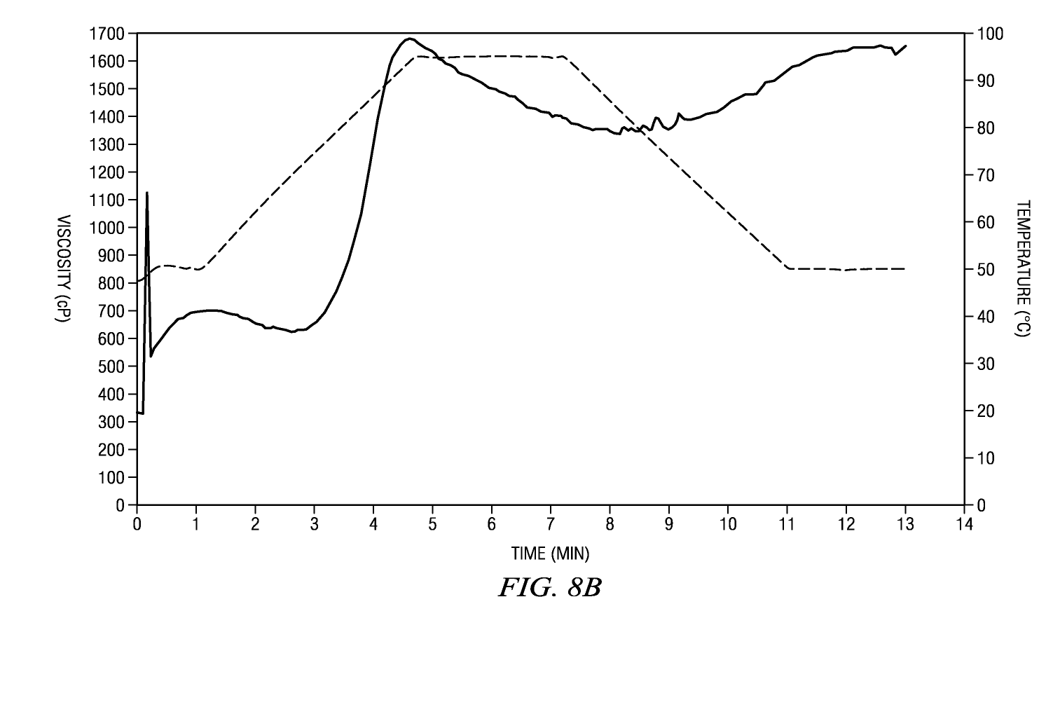

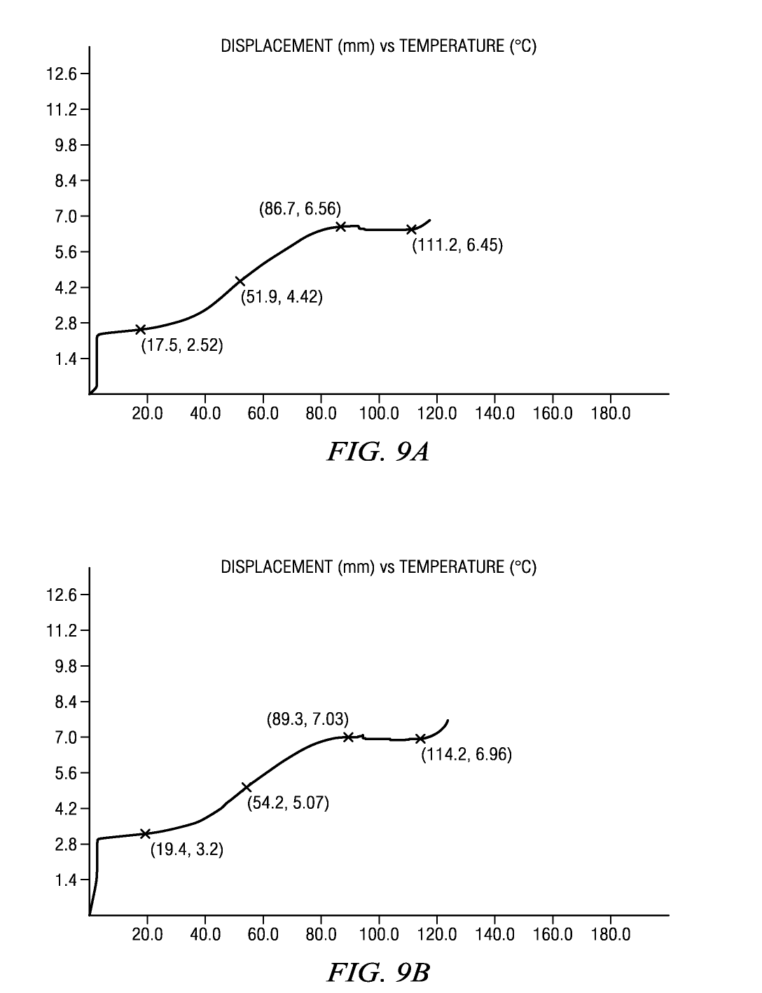

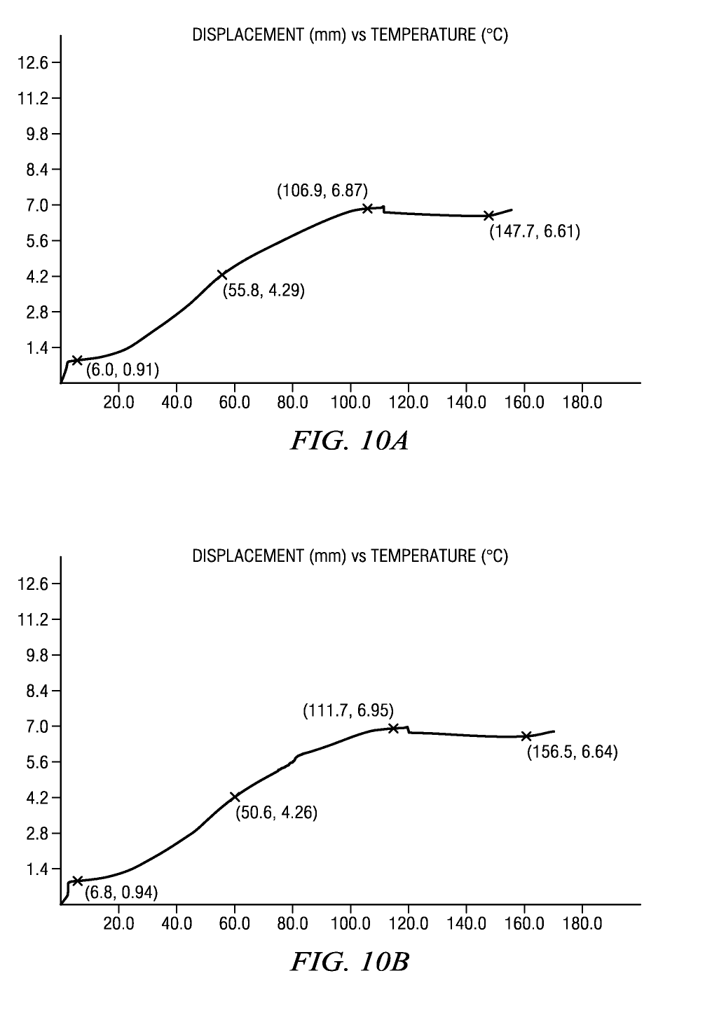

Suitable micropellets made by way of extrusion in one embodiment were analyzed using three analytical techniques for testing starch gelatinization and degree of macromolecular degradation-1) differential scanning calorimetry (DSC), 2) rapid visco analysis (RVA), and 3) phase transition analysis (PTA). Results, further discussed below and illustrated in part beginning with FIG. 6A, indicated that the extruded micropellets used in some embodiments described herein completely gelatinize and exhibit an RVA peak viscosity of 63.5 cP, PTA flow of 112.7, and softening temperatures of about 53.0° C. Micropellets made by way of marumerization (MRM), which were not suitable for the methods described herein, were also tested to compare with the extruded micropellets (EXT) successfully used. Marumerization techniques are often used in the production of animal feed pellets, for example.

### Sample Preparation

A falling number mill was used to grind the samples in a two-pass process, followed by sieving to obtain particle size below 500 μm. The moisture content of the ground sample was measured using AACC air oven method 44-19 in a Model 160DM Thelco Lab Oven (Precision Scientific, Chicago, Ill.) at 135° C. for 2 hours. The original moisture content of the samples was 10.1% (EXT1) and 10.5% (MRM). All moisture contents are expressed on wet basis.

Differential Scanning calorimetry (DSC)

Approximately 10 mg of samples were hydrated to 66% moisture, sealed in steel pans and equilibrated overnight in a refrigerator. A standard gelatinization test was conducted by heating the pans in the DSC (Q100, TA Instruments, New Castle, Del.) from 10° to 140° C. at a heating rate of 10° C./min. Gelatinization temperature range (onset, peak and end) and enthalpy were determined for each sample. All tests were carried out in duplicate.

FIG. 12A depicts the DSC scan for the extruded micropellets (EXT). FIG. 12B depicts the DSC scan for micropellets made by way of marumerization (MRM). The corresponding data for the residual gelatinization properties of the MRM sample can be found below in Table 7.

TABLE 7
Residual gelatinization properties of MRM micropellets

| | MRM rep1 | MRM rep2 | Avg | Std Dev |
|---|---|---|---|---|
| Start temp | 68.35 | 67.72 | 68.04 | 0.45 |
| (° C.) | | | | |
| Peak temp | 76.04 | 75.71 | 75.88 | 0.23 |
| (° C.) | | | | |
| End temp | 88.12 | 85.82 | 86.97 | 1.63 |
| (° C.) | | | | |
| Enthalpy | 4.176 | 4.584 | 4.38 | 0.29 |
| (J/g) | | | | |

Both replicates of the DSC scans revealed that the EXT sample did not exhibit any peak, which indicates that the starch in the EXT micropellets was completely gelatinized. On the other hand, the MRM sample had a residual gelatinization peak, which indicates that a substantial portion of the starch in the product was still ungelatinized. Specifically, Table 7 indicates a peak gelatinization temperature of 75.88±0.23 that is fairly typical for many starches. The typical gelatinization enthalpy of native starches range from 5-20 J/g. The MRM sample had a residual enthalpy of gelatinization of 4.38±0.29 J/g, confirming that a substantial amount of the starch was ungelatinized.

### Rapid Visco Analysis (RVA)

Pasting properties of the EXT and MRM samples were also determined using a rapid visco analyser (RVA4, Newport Scientific Pty. Ltd., Australia). For RVA analysis, sample moisture was first adjusted to 14% by adding distilled water. Specifically, 3 grams of sample was added to 25 ml of water in an aluminum test canister. The RVA was preheated to 50° C. for 30 minutes prior to testing. A 13 min standard RVA temperature profile was used: 1 min holding at 50° C., 3 minutes 42 second temperature ramp up to 95° C., 2 minutes 30 seconds holding at 95° C., 3 minutes 48 second temperature ramp down to 50° C., and 2 minutes holding at 50° C. Pasting properties, such as peak, trough and final viscosities, were determined. All tests were carried out in duplicate.

The results of the RVA are summarized below in Table 8. The RVA pasting curves for the sample runs of the EXT samples are shown in FIGS. 13A and 13B.

TABLE 8
Pasting (RVA) parameters for (a) EXT and (b) MRM samples.

| | | | Break- | | | Peak | Pasting |
|---|---|---|---|---|---|---|---|
| | Peak | Trough | down | Final | Setback | time | Temp |
| | (cP) | (cP) | (cP) | (cP) | (cP) | (min) | (° C.) |
| (a) | | | | | | | |
| EXT1 | 79.0 | 15.0 | 64.0 | 46.0 | 31.0 | 6.9 | 57.4 |
| rep1 | | | | | | | |
| EXT1 | 48.0 | 1.0 | 47.0 | 62.0 | 61.0 | 1.7 | 95.0 |
| rep2 | | | | | | | |
| Average | 63.5 | 8.0 | 55.5 | 54.0 | 46.0 | 4.3 | 76.2 |
| Std Dev | 21.9 | 9.9 | 12.0 | 11.3 | 21.2 | 3.7 | 26.6 |
| (b) | | | | | | | |
| MRM | 1682.0 | 1340.0 | 342.0 | 1650.0 | 310.0 | 4.6 | 75.9 |
| rep1 | | | | | | | |
| MRM | 1841.0 | 1424.0 | 417.0 | 1789.0 | 365.0 | 4.7 | 50.2 |
| rep2 | | | | | | | |
| Average | 1761.5 | 1382.0 | 379.5 | 1719.5 | 337.5 | 4.6 | 63.0 |
| Std Dev | 112.4 | 59.4 | 53.0 | 98.3 | 38.9 | 0.0 | 18.2 |

The EXT sample did not exhibit much increase in viscosity as the testing proceeded. As shown in Table 8, the EXT sample comprised an average peak viscosity of about 63.5 cP. This indicates that the starch fraction was degraded during the processing and had lost all or most of its swelling capacity. On the other hand, as depicted in FIGS. 14A and 14B, the MRM sample had a substantially higher peak viscosity. Table 8 shows the average peak viscosity for the MRM sample runs to be about 1761.5 cP, which indicates that their processing conditions were less severe and the starch fraction retained its swelling capacity.

### Phase Transition Analyzer (PTA)

PTA is a relatively new method for determining the softening temperature (Tₛ) and flow temperature (T_{f}) of a bio polymeric material. These are flow-based measurements and are similar to glass transition (T_{g}) and melting (Tₘ) temperatures, although the latter are thermal events. The PTA characterizes softening and flow transitions of complex recipes by using a combination of time, temperature, pressure and moisture. It consists of two sealed chambers separated by an interchangeable capillary die. The chambers house electric heaters and contain a hollow cavity for cooling fluid. The pistons are mounted together through sidebars. Air cylinders are mounted at the bottom and maintained at constant pressure. A linear-displacement transducer measures the sample's deformation, compaction and flow relative to initial sample height, as the sample temperature is raised at a set rate under pressurized conditions.

For phase transition analysis of the EXT and MRM samples, samples were equilibrated overnight in a relative humidity chamber at 99% RH for adjustment of moisture. The final moistures prior to testing were 12.5 and 13%, respectively, for EXT and MRM. Approximately 2 g sample was introduced into the test chamber of the Phase Transition Analyzer (Wenger Manufacturing Inc., Sabetha, Kans.) and subject to initial compaction at 100 kPa with a blank die (no opening) underneath. Temperature was then ramped up at 8° C. per min with a starting temperature of 1° C., while maintaining the chamber pressure at 80 kPa. Ts was obtained as the midpoint of the temperature range over which the sample exhibited softening (displacement over a set threshold of 0.0106 mm/° C. as measured by a transducer). The blank die was then replaced by a 2 mm capillary die and heating was continued. T_{f} was obtained as the temperature at which the sample started to flow through the capillary.

The results of the PTA scans are shown in FIGS. 15A and 15B (EXT runs) and FIGS. 16A and 16B (MRM runs), with corresponding data summarized below in Table 9.

TABLE 9
PTA data

| | Tₛ(° C.) | | | | T_{f}(° C.) | | | |
|---|---|---|---|---|---|---|---|---|
| | Rep1 | Rep2 | Avg | Std Dev | Rep1 | Rep2 | Avg | Std Dev |
| EXT | 54.2 | 51.9 | 53.0 | 1.6 | 114.2 | 111.2 | 112.7 | 2.1 |
| MRM | 55.8 | 58.6 | 57.2 | 2.0 | 163.5 | 157.9 | 160.7 | 4.0 |

The above PTA data supports the inference made from analysis of RVA results. The EXT sample had lower Tₛ than the MRM sample (average Tₛ of 53.0±1.6° C. versus 57.2±° C.), with the replicates showing a range of Tₛ of from about 51.9° C. to about 54.2° C. The former also had a substantially lower T_{f} (112.7±2.1° C. versus 160.7±4.0° C.), with a range of T_{f} of from about 111.2° C. to about 114.2° C. This indicates that the EXT micropellets had a higher macromolecular degradation than the MRM.

All parts and percentages described herein are by weight unless otherwise indicated. While this invention has been particularly shown and described with reference to preferred embodiments, it will be understood by those skilled in the art that various changes in form and detail may be made therein without departing from the spirit and scope of the invention. For example, one skilled in the art, armed with this disclosure, will recognize that combinations using seed materials and micropellets together with a starch-based component as described herein may also produce collets comprising more than one color and/or varied texture and flavor. Thus, this invention is not intended to be limited to the embodiments shown, but is to be accorded the widest scope consistent with the principles and features disclosed herein.

What is claimed is:

1. A method for producing a plurality of bi-colored random collets, said method comprising the steps of:
a) introducing a monochromic starch-based component into a random extruder, said monochromic starch-based component comprising an expandable starch;
b) introducing a non-liquid colored component into said extruder, said colored component comprising a color unlike that of said monochromic starch-based component, wherein said monochromic starch-based component and said colored component form a color-comprising mixture; and
c) extruding said color-comprising mixture through said random extruder, thereby producing a plurality of bi-colored collets.

2. The method of claim 1 wherein said color-comprising mixture comprises said starch-based component and said colored component at a ratio of at least about 98:2.

3. The method of claim 1, wherein said monochromic starch-based component is selected from the group consisting of corn meal, rice meal, and combinations or derivations thereof.

4. The method of claim 1, wherein said colored component comprises naturally colored blue corn meal.

5. The method of claim 1 wherein said colored component comprises a starch, said starch having undergone a coloration process to produce said color unlike that of said monochromic starch-based mixture.

6. The method of claim 1 wherein said colored component comprises artificial coloring.

7. The method of claim 6 wherein said artificial coloring comprises one or more fat-soluble colors.

8. The method of claim 1 further comprising the step of hydrating said starch-based component and coloring component to a moisture content of between about 11% to about 15.5%.

9. The method of claim 1 wherein said colored component comprises a seed or product derived therefrom.

10. The method of claim 1 wherein said colored component comprises a ground seed comprising a particle size similar to that of said starch-comprising component.

11. The method of claim 1 wherein said colored component comprises a seed derived from a plant, said seed comprising a size of between about 250 to about 600 microns.

12. The method of claim 1 wherein said colored component comprises a plurality of micropellets comprised of agglomerated fine particles.

13. The method of claim 12 wherein said agglomerated fine particles comprise flavor.

14. The method of claim 13 wherein said flavor comprises chipotle.

15. The method of claim 12 wherein said agglomerated fine particles comprise a sea vegetable.

16. The method of claim 15 wherein said micropellets comprise about 10% sea vegetable and between about 89% to about 90% starch-comprising component.

17. The method of claim 12 wherein said micropellets comprise about 10% liquid with about 90% starch-comprising component.

18. The method of claim 12 wherein said micropellets comprise about 100% fine particles.

19. The method of claim 12 wherein said micropellets comprise between about 20% to about 40% starch-comprising component, said starch-comprising component derived from the group consisting of corn, rice, potato, or any combination thereof.

20. The method of claim 12 wherein said micropellets comprises a phase transition analysis flow temperature ranging from between about 111.2° C. to about 114.2° C.

21. The method of claim 12 wherein said micropellets comprise a phase transition analysis flow softening temperature ranging from between about 51.9° C. to about 54.2° C.

22. The method of claim 1 further comprising cooking said plurality of bi-colored collets to produce a shelf-stable snack food product, wherein said cooking is selected from the group consisting of frying and baking.

23. The method of claim 22 further comprising the step of seasoning the bi-colored collets.

24. The plurality of bi-colored collets produced by the method of claim 1.

25. A collet formed by random extrusion, wherein said collet comprises a first color and a second color within the base of said collet.

26. The collet of claim 25 wherein said first color comprises a starch-comprising component.

27. The method of claim 26 wherein said starch-comprising component is selected from the group consisting of corn, rice and potato.

28. The collet of claim 26 wherein said second color comprises a seed material, said seed material providing a color unlike that of said first color.

29. The collet of claim 26 wherein said second color is provided by a plurality of micropellets, said micropellets providing a color unlike that of said first color.

30. The collet of claim 26 wherein said first color and said color provide for a marbled pattern.

31. A micropellet for coloring a collet product produced by random extrusion, said micropellet comprising a plurality of agglomerated particles, and further wherein said micropellet comprises a color unlike that of a starch-based component selected from the group consisting of corn, potato and rice.

32. The micropellet of claim 31 wherein said agglomerated particles are selected from the group consisting of starch, proteins, fruits, berries, vegetables, minerals, vitamins, herbs, fibers, grains, beans, fish, seafood, meats, peas, botanical proteins, flavors, probiotics, or a combination thereof.

33. The micropellet of claim 31 wherein said micropellets comprise between 89% to about 90% starch and about 10% liquid, said liquid derived from one or more of proteins, fruits, berries, vegetables, minerals, vitamins, herbs, fibers, grains, beans, fish, seafood, meats, peas, botanical proteins, flavors, and probiotics.

34. The micropellet of claim 31 comprising a diameter no larger than about 1.8 mm.

35. The micropellet of claim 31 further comprising a starch-comprising component.

36. The micropellet of claim 35 wherein said starch-comprising component is derived from corn.
